(19) United States
(12) Patent Application Publication
(10) Pub. No.: US 2007/0158256 A1
(43) Pub. Date: Jul. 12, 2007

(54) Apparatus and method for micro or ultrafiltration

(75) Inventors: Jantje Kromkamp, Ede (NL); Albert van der Padt, Apeldoorn (NL); Cornelis Petrus Jacobus Maria van der Vorst, Arnhem (NL)

Correspondence Address: NORRIS, MCLAUGHLIN & MARCUS, P.A., 875 THIRD AVE, 18TH FLOOR, NEW YORK, NY, 10022, US

(73) Assignee: FRIESLAND BRANDS B.V., Meppel (NL)

(21) Appl. No.: 10/597,840

(22) PCT Filed: Feb. 10, 2005
(86) PCT No.: PCT/NL05/00098

§ 371 Date: Aug. 9, 2006

(30) Foreign Application Priority Data
Feb. 11, 2004 (NL) 1025459

(51) Int. Cl. B01D 65/02

(52) U.S. Cl. 210/321.69; 210/108; 210/427; 210/321.65

(57) ABSTRACT

An apparatus provided with a micro or ultrafiltration filter, wherein the filter is provided with a filter housing having a retentate side and a permeate side, wherein the retentate side and the permeate side are separated from each other by filter material, wherein a fluid supply pipe is connected to the retentate side and a permeate discharge pipe to the permeate side, wherein, in the permeate discharge pipe, a shut-off valve operable at a high frequency is provided and wherein means are connected to the permeate side for increasing the pressure in the permeate side when the said shut-off valve is closed to a value which is higher than the pressure on the retentate side.

The invention relates to an apparatus provided with a micro or ultrafiltration filter, where the filter is provided with a filter housing having a retentate side and a permeate side, where the retentate side and the permeate side are separated from each other by filter material, where a fluid supply pipe is connected to the retentate side and a permeate discharge pipe to the permeate side.

Such an apparatus is known from practice. Micro or ultrafiltration are filtration processes used to separate fluids on the basis of a difference in particle or molecule dimensions. For this purpose, filter material is used with a pore diameter of the order of magnitude of 0.1-10 micrometer (microfiltration) or with a MWCO (molecular weight cut off) of 1 kDa to about 200 kDa (ultrafiltration). In practice, such filter material is also referred to by the term filter membrane. Examples of applications are concentrating proteins in milk, removing microorganisms and clearing fruit is juices and wine. Important process parameters for micro and ultrafiltration are the flux and the selectivity. The flux relates to the amount of fluid that permeates per time unit and per unit of filter material surface and is an indicator of the capacity of the process. The selectivity indicates the ratio of the concentration of two components to be separated in the permeate in relation to the starting fluid and is a measure of the efficiency of the separation step.

A problem of micro and ultrafiltration is that the filter material pollutes very rapidly; blocked components accumulate against and in the filter material and this adversely affects the flux and the selectivity of the process. It has already been proposed to clean the filter material by reversing the fluid flow in the filter material. In the literature, such an action is referred to by the term back pulsing. A description thereof is given in European patent application EP-A-0 588 348. The solution described in that publication is not suitable for high-frequency back pulsing. A high frequency is desired to keep the filter material as clean as possible. In addition, the back pulse needs to take as short a time as possible to adversely affect the capacity of the filtration process as little as possible.

These objects are insufficiently achieved with the apparatus described in the European application. The invention contemplates an apparatus in which these objects are achieved. For this purpose, according to the invention, the apparatus of the type described in the introduction is characterized in that in that a shut-off valve operable at a high frequency is provided in the permeate discharge pipe, while means are connected to the permeate side for increasing the pressure in the permeate side when the shut-off valve is closed to a value higher than the pressure on the retentate side.

The means for increasing the pressure need to be designed such that the pressure on the permeate side increases very fast to above the pressure prevailing in the retentate side. This is because then, in a minimal period of time, the back pulse can be effected, after which the shut-off valve can be opened again and the normal filtration process can take place again. Thus, the capacity of the filtration process is hardly adversely affected.

According to a further elaboration of the invention, a very rapid pressure build-up can be obtained with an apparatus in which the shut-off valve is designed to be opened and closed periodically, with the shut-off valve being kept in a closed position so long that a higher pressure is built up on the permeate side than on the retentate side, such that a reversal of the fluid flow in the filter material occurs, while the means for increasing the pressure in the permeate side are designed such that, for the rest, a reversal of flow direction of fluid in pipes of the apparatus is prevented. Because there no reversal of the flow direction of fluid volumes occurs in any of the pipes, the slowness in the system during the building up of the hydrostatic pressure on the permeate side will be minimal.

Such an apparatus may, for instance, be realized in that the means for increasing the pressure comprise at least one permeate circulation circuit which is, on the one side, connected, by an inlet, to the permeate discharge pipe at a point downstream of the shut-off valve and, on the other side, by an outlet, to the permeate side of the filter housing, while a permeate circulation pump is provided in the permeate circulation circuit.

In a thus designed apparatus, in an opened condition of the shut-off valve, permeate is pumped around through the permeate circulation circuit.

As soon as the shut-off valve is in a closed position, the pressure will increase downstream of the permeate circulation pump, resulting in the pressure in the permeate side of the filter housing increasing. When the shut-off valve remains closed long enough, the pressure on the permeate side will become higher than on the retentate side and back pulsing will occur.

By suddenly closing the shut-off valve, pressure instability in the pipe system can occur, when could result in, for instance, water shock. In order to prevent this phenomenon, according to a further elaboration, it is particularly favorable if, upstream of the outlet of the permeate circulation circuit and downstream of the permeate circulation pump, a restriction is included in order to prevent a jerky pressure build-up.

In addition, in the permeate circulation circuit, a permeate buffer tank may be included for feeding the pump during the closed condition of the shut-off valve.

According to a further elaboration of the invention, it is particularly favorable if the fluid supply pipe is connected to a first end of the retentate side of the filter housing, while a retentate circulation circuit is provided, while an inlet of the retentate circulation circuit is connected to a second end of the retentate side of the filter housing, while an outlet of the retentate circulation circuit is connected to the fluid supply pipe, while a retentate circulation pump is provided in the retentate circulation circuit, while the first end is opposite the second end, such that, with a switched-on retentate circulation pump, a cross-flow along the filter material occurs. Such a cross-flow results in a cleaning action of the filter material which, in combination with the above-described back pulsing, results in an improved selectivity and flux of the filter material.

According to a further elaboration of the invention, it is favorable if the outlet of the permeate circulation circuit is connected to a first end of the permeate side of the filter housing, while the permeate discharge pipe is connected to a second end of the permeate side of the filter housing, while the first end is opposite the second end, such that, on the permeate side of the filter housing, a cross-flow along the filter material occurs, while the cross-flow on the retentate side has the same flow direction as the cross-flow on the permeate side.

It has been found that, on the retentate side, under the influence of the cross-flow prevailing there, a pressure drop prevails in the filter housing viewed in the cross-flow direction. This therefore results in the pressure on the retentate side of the filter material not being equal over the whole surface of the filter material. If there is an equal pressure everywhere on the permeate side of the filter material, the result will be that the pressure drop over the filter material viewed over the surface of the filter material varies. This in turn results in the flow rate through the filter material viewed over the surface of the filter material not being equal everywhere. By now ensuring that the cross-flow on the retentate side has the same flow direction as the cross-flow on the permeate side, a substantially equal pressure drop can be effected over the whole surface of the filter material.

According to a further elaboration of the invention, in opened condition of the shut-off valve, the circulation in both circulation circuits mentioned is such that the pressure drop is substantially equal over the whole surface of the filter material.

According to a further elaboration of the invention, more than one permeate circulation circuit can be provided for forming a corresponding number of back pulse pressure areas on the permeate side of the filter housing. This has the advantage that, in the part in the filter where more pollution occurs, back pulsing can, for instance, take place more often and/or using more volume and/or counterpressure. This has the advantage that, with severely polluting areas, the cleaning can be carried out more thoroughly and/or more regularly than in areas where the pollution is only limited.

It will be clear that the retentate circulation circuit is also connected to a retentate discharge pipe.

According to a further elaboration of the invention, it is particularly favorable when the frequency at which the shut-off valve is operable is in the range of 1-1000 Hertz. At such a frequency, an excellent selectivity can be preserved as well as an improvement of the capacity of the apparatus. Viewed in time, the shut-off valve may, for instance, be closed 2-50% and opened 50-98%.

According to a further elaboration of the invention, the shut-off valve may comprise a valve housing in which a rotating camshaft is arranged, while the cam of the camshaft forms a closure in a certain range of rotational positions and allows a free passage of permeate in other positions, the camshaft being continuously drivable. Such as shut-off valve has a simple construction. Preferably, the rotational speed of the camshaft is controllable for controlling the back-pulse frequency.

The invention further relates to a method for operating an apparatus according to the invention, where, in the filter housing, periodically at a high frequency, a higher pressure is built up on the permeate side than on the retentate side, such that a reversal of the fluid flow in the filter material occurs, while, for the rest, a reversal of flow direction of fluid volumes in pipes of the apparatus is prevented.

According to a further elaboration of the method according to the invention, in both the retentate and the permeate side of the filter housing, a cross-flow can be maintained for a further improvement of the flux and the selectivity of the filter material and for maintaining a substantially equal pressure drop over the whole surface of the filter material.

The invention will now be explained on the basis of two exemplary embodiments with reference to the drawing, in which:

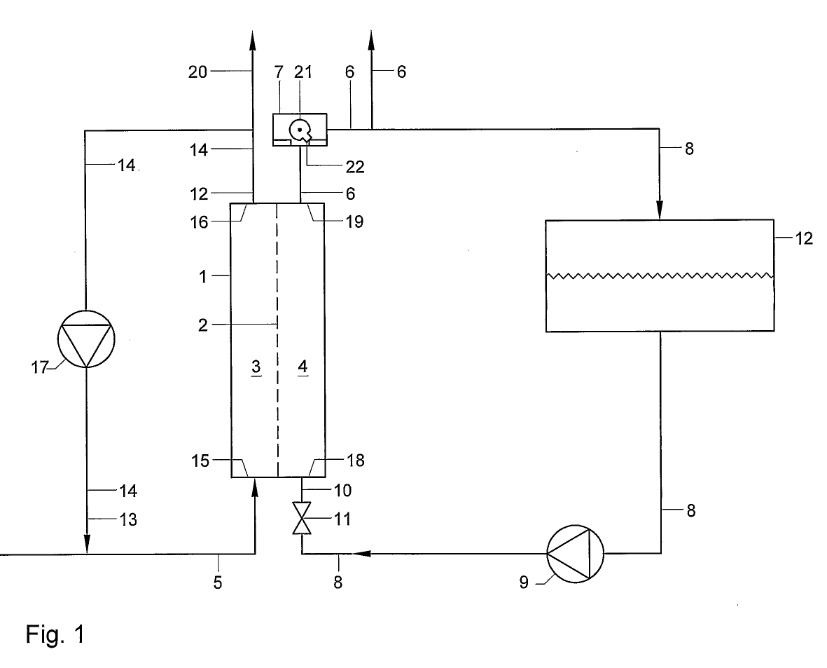

FIG. 1 shows a first exemplary embodiment of the apparatus according to the invention;

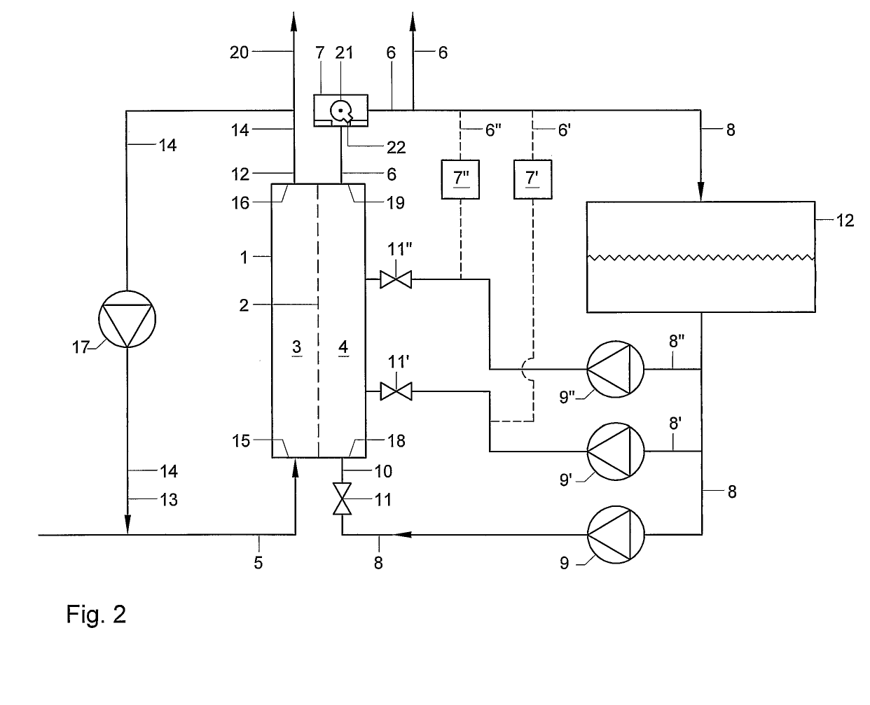

FIG. 2 shows a second exemplary embodiment; and

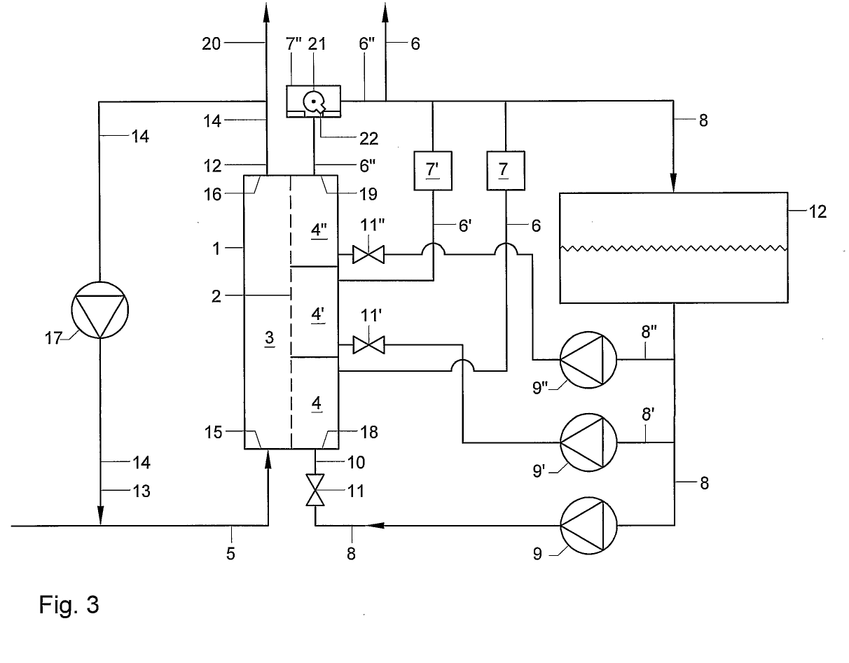

FIG. 3 shows a third exemplary embodiment.

The Figures all shows an exemplary embodiment of the apparatus where the filter housing is designated by 1. In the filter housing, filter material 2 is included which is usually designed as a filter membrane in practice. The filter membrane 2 divides the filter housing into a retentate side 3 and a permeate side 4. To the retentate side 3, a fluid supply pipe 5 is connected. To the permeate side 4, a fluid discharge pipe 6 is connected. In the permeate discharge pipe 6, near the filter housing 1, a shut-off valve 7 operable at a high frequency is included. Further, a permeate circulation circuit is provided which comprises a circulation pipe 8. The permeate circulation pipe 8 is connected, by an inlet, to the permeate discharge pipe 6 at a point downstream of the shut-off valve 7. An outlet of the permeate circulation pipe 8 is connected to the permeate side of the filter housing 1. In the permeate circulation pipe 8, a permeate circulation pump 9 is provided. Downstream of the pump 9 and upstream of the outlet 10, a restriction 11 is included in order to prevent jerky pressure build-up. Further, in the permeate circulation pipe 8, a permeate buffer tank 12 is included for feeding the permeate circulation pump 9 during the closed position of the shut-off valve 7. The fluid supply pipe 5 is connected to a first end 15 of the retentate side 3 of the filter housing 1. Further, a retentate circulation circuit is provided of which the inlet 12 is connected to a second end 16 of the retentate side 3 of the filter housing 1. An outlet 13 of the retentate circulation circuit is connected to the fluid supply pipe 5. In the retentate circulation circuit, which comprises a retentate circulation pipe 14, a retentate circulation pump 17 is provided. The first end 15 is opposite the second end 16, such that, with a switched-on retentate circulation pump 17, a cross-flow along the filter membrane 2 occurs. The outlet 10 of the permeate circulation circuit 8 is connected to a first end 18 of the permeate side of the filter housing 1. The permeate discharge pipe 6 is connected to a second end 19 of the permeate side 4 of the filter housing 1. The first end 18 is opposite the second end 19, such that, on the permeate side of the filter housing 1, a cross-flow along the filter material 2 occurs. The cross-flow on the retentate side 3 has the same flow direction as the cross-flow on the permeate side 4. Here, the permeate circulation pump 9 and the retentate circulation pump 17 are preferably controlled such that, in opened condition of the shut-off valve 7, the circulation in both circulation circuits is such that the pressure drop is substantially equal over the whole surface of the filter material 2. To the retentate circulation circuit 14, further, a retentate discharge pipe 20 is connected for discharging the retentate not recirculated via the recirculation pipe 14.

The shut-off valve 7 is provided with a valve housing in which a rotating camshaft 21 is arranged. A cam 22 on the camshaft 21 forms a closure in a certain range of rotational positions and allows a free passage of permeate in the other positions. Preferably, the camshaft 21 is continuously drivable and the rotational speed of the camshaft 21 is controllable for controlling the back-pulse frequency.

With the exemplary embodiment shown in FIG. 1, in the filter housing 1, periodically at a high frequency, a higher pressure can be built up on the permeate side than on the retentate side, such that a reversal of the fluid flow in the filter material 2 occurs and where, for the rest, a reversal of the flow direction of fluid volumes in the pipes of the apparatus is prevented. The result of all this is that a very high back-pulse frequency can be used. By combining this high back-pulse frequency with a cross-flow on both the permeate side 4 and the retentate side 3, an excellent cleaning of the filter material or the filter membrane 2 is obtained without the capacity of the apparatus being reduced considerably as a result of the back pulsing. The selectivity and the flux remain high and the process can be continued for a prolonged time.

The exemplary embodiments of FIGS. 2 and 3 differ from the exemplary embodiment of FIG. 1 in that three permeate circulation circuits 8, 8′, 8″ are present. Each permeate circulation circuit can be provided with its own pump 9, 9′, 9″ as shown. Each permeate circulation pump 9, 9′, 9″ then produces its own back-pulse pressure. However, it is also possible that only one pump is provided for all permeate circulation circuits and that the back-pulse pressures in the different circuits differ from one another in that, in each permeate circulation circuit, a different restriction 11, 11′, 11″ is included.

In the exemplary embodiment of FIG. 2, dotted lines indicate that, downstream of the permeate circulation pumps 9, 9′, 9″, short-circuit pipes are connected, which are each, by an outlet, connected to the permeate discharge pipe 6 downstream of the shut-off valve 7. In each of these short-circuit pipes, a shut-off valve 7′, 7″ needs to be present that is normally closed but that can be opened when the shut-off valve 7 is closed to prevent the back pulse of the respective permeate circulation circuit. In this manner, the frequency of the back pulsing can be varied per permeate circulation circuit. For this purpose, the shut-off valves 7′, 7″ can be designed as pulsing shut-off valves.

In the exemplary embodiment of FIG. 3, the permeate side 4 of the filter housing 1 is divided into three compartments 4, 4′, 4″. To each compartment 4, 4′, 4″, a permeate circulation pump 8, 8′, 8″ is connected at an upstream end of the compartment 4, 4′, 4″. Further, to each compartment 4, 4′, 4″, a discharge pipe 6, 6′, 6′″ is connected at a downstream end of the compartment. In each discharge pipe 6, 6′, 6″, a pulsing shut-off valve 7, 7′, 7″ is included for creating back-pulse behavior specific to the respective compartment. The shut-off valves 7, 7′, 7″ can be designed in the manner as described with reference to the first exemplary embodiment. Both for the exemplary embodiment of FIG. 2 and that of FIG. 3, it holds true that the (pulsing) shut-off valves 7, 7′, 7″ can be synchronized, for instance in that one camshaft is provided which bears a cam for each shut-off valve. In this context, synchronizing is to be understood in a broad sense, in the sense that the opening and closing of the various shut-off valves are geared to one another.

It is clear that the invention is not limited to the exemplary embodiment described but that various modifications are possible within the framework of the invention as defined by the claims.

1. An apparatus provided with a micro or ultrafiltration filter, wherein the filter is provided with a filter housing (1) having a retentate side (3) and a permeate side (4), wherein the retentate side and the permeate side are separated from each other by filter material (2), wherein a fluid supply pipe (5) is connected to the retentate side (3) and a permeate discharge pipe (6) to the permeate side (4), wherein, in the permeate discharge pipe (6), a shut-off valve (7) operable at a high frequency is provided and wherein means (8-11) are connected to the permeate side (4) for increasing the pressure in the permeate side (4) when the said shut-off valve (7) is closed to a value which is higher than the pressure on the retentate side (3).

2. An apparatus according to claim 1, wherein the shut-off valve (7) is designed to be opened and closed periodically, wherein the shut-off valve (7) is kept in a closed position so long that a higher pressure is built up on the permeate side (4) than on the retentate side (3), such that a reversal of the fluid flow in the filter material (2) occurs, wherein the means (8-11) for increasing the pressure in the permeate side (4) are designed such that, for the rest, a reversal of flow direction of fluid volumes in pipes of the apparatus is prevented.

3. An apparatus according to claim 1, wherein the means (8-11) for increasing the pressure comprise at least one permeate circulation circuit (8) which is, on the one side, connected, by an inlet, to the permeate discharge pipe (6) at a point downstream of the shut-off valve (7) and, on the other side, by an outlet (10), to the permeate side (4) of the filter housing (1), wherein a permeate circulation pump (9) is provided in the permeate circulation circuit.

4. An apparatus according to claim 3, wherein, upstream of the outlet (10) of the permeate circulation circuit (18) and downstream of the pump (9), a restriction (11) is included in order to prevent a jerky pressure build-up.

5. An apparatus according to claim 3, wherein, in the permeate circulation circuit (8), a permeate buffer tank (12) is provided for feeding the permeate circulation pump (9) during the closed condition of the shut-off valve (7).

6. An apparatus according to claim 1, wherein the fluid supply pipe (5) is connected to a first end (15) of the retentate side (3) of the filter housing (1), wherein a retentate circulation circuit (14) is connected to a second end (16) of the retentate side (3) of the filter housing (1), wherein an outlet (13) of the retentate circulation circuit (14) is connected to the fluid supply pipe (5), wherein a retentate circulation pump (17) is provided in a retentate circulation circuit (14), wherein the first end (15) is opposite the second end (16), such that, with a switched-on retentate circulation pump (17), a cross-flow along the filter material (2) occurs.

7. An apparatus according to claim 6, wherein the outlet (10) of the permeate circulation circuit is connected to a first end (18) of the permeate side (4) of the filter housing (1), wherein the permeate discharge pipe (6) is connected to a second end (19) of the permeate side (4) of the filter housing (1), wherein the first end (18) is opposite the second end (19), such that, on the permeate side (4) of the filter housing (1), a cross-flow along the filter material (2) occurs, wherein the cross-flow on the retentate side (3) has the same flow direction as the cross-flow on the permeate side (4).

8. An apparatus according to claim 7, wherein, in opened condition of the said shut-off valve (7), the circulation in both said circulation circuits (8, 14) is such that the pressure drop is substantially equal over the whole surface of the filter material (2).
